(19) United States
(12) Patent Application Publication
(10) Pub. No.: US 2009/0248518 A1
(43) Pub. Date: Oct. 1, 2009

(54) SALES SUPPORT APPARATUS, COMPUTER-READABLE RECORDING MEDIUM HAVING RECORDED THEREIN SALES SUPPORT PROGRAM, AND SALES SUPPORT METHOD

(75) Inventor: Hiroomi Shigematsu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/362,903

(22) Filed: Jan. 30, 2009

(30) Foreign Application Priority Data
Mar. 28, 2008 (JP) 2008-085933

(51) Int. Cl. G06Q 20/00

(52) U.S. Cl. 705/14; 705/35

(57) ABSTRACT

A sales support apparatus including a customer information storage unit that stores the credit information of each customer is provided. The sales support apparatus includes a transaction history storage unit that stores the history of past transactions with the customer. The transaction condition storage unit stores the transaction conditions corresponding to the combination of the customer credit information and the transaction history. The transaction condition determining unit, upon application thereto of a transaction condition acquisition request designating the customer company from an order terminal, acquires the credit information of the prospective customer from the customer information storage unit, acquires the transaction history with the prospective customer from the transaction history storage unit and by accessing the transaction condition storage unit, determines the transaction conditions corresponding to the credit information and the transaction history of the prospective customer. The transaction condition transmission unit transmits the transaction conditions to the order terminal.

### CROSS-REFERENCE TO RELATED APPLICATION(S)

This application is related to and claims priority to Japanese patent application no. 2008-85933 filed on Mar. 28, 2008 in the Japan Patent Office, and incorporated by reference herein.

### BACKGROUND

1. Field of the Invention

The embodiments discussed herein are directed to a sales support apparatus for supporting the sales of a commodity, a computer-readable recording medium having recorded therein a sales support program and a sales support method.

2. Description of the Related Art

A distributor of a product or the like may have a purchase consultation window for the product sale through the telephone or internet. This purchase consultation window receives a request from various companies including those of an unknown credit standing to purchase a commodity. These purchase requests include ones from corporate customers wanting to purchase on credit. In the purchase on credit, the commodity is delivered first and the price is paid later. Therefore, the distributor may not be able to receive the price. Thus, the sale on credit is accompanied by a risk.

In view of this, the distributor is required to reject the request for credit sale from an unreliable prospective purchaser. Before the sale on credit, the distributor investigates the credit standing of the prospective customer on documents. The credit standing of the prospective customer is judged based on the credit information acquired from a credit bureau, for example, on the particular prospective purchaser. Only in the case where the prospective customer is judged as a reliable company in this way, the commodity is sold on credit.

During the examination of the credit standing of a prospective purchaser, a variety of items including the “scale”, “business achievement” and “history” of the company are checked, and in many cases, required to be notified to and acquire permission from the accounting department. This examination is ideally carried out quickly, and if protracted, may cause the prospective customer to rethink the purchase of the commodity, often leading to the loss of the sales chance. In order to quicken the examination by the accounting department, therefore, a system has been conceived in which the information required for examination are attached to the examination request and stored in a data base, which examination request is transmitted at the request of a branch office.

The advisability of signing a sales contract is determined not only based on the credit information of the prospective customer from a credit bureau but also taking other factors such as the past transactions with the particular distributor and a requested purchase quantity into consideration. The information acquired from other sources than the credit bureau include the information in the Web site opened by the prospective customer company and the data stored in the customer information data base held by the distributor. These information are checked and attached to the written examination request by the salesperson of the distributor. Considerable time is required, therefore, to collect and rearrange the information. As a result, a considerable length of time is still required before judging whether the actual sale to the prospective customer is possible or not.

### SUMMARY OF THE INVENTION

It is an aspect of the embodiments discussed herein to provide a sales support apparatus, a computer-readable recording medium having recorded therein a sales support program and a sales support method which permit the transaction conditions to be determined quickly taking the credit information and the customer information held in the distributor into consideration.

The above aspects may be attained by a sales support apparatus including a customer information storage unit, a transaction history storage unit, a transaction condition storage unit, a transaction condition determining unit and a transaction condition transmission unit, wherein the customer information storage unit stores the credit information of each customer, wherein the transaction history storage unit stores the history of past transactions with the customer, wherein the transaction condition storage unit stores the transaction conditions corresponding to the combination of the customer credit information and the transaction history, wherein the transaction condition determining unit, upon application thereto of a transaction condition acquisition request designating the customer company from an order terminal, acquires the credit information of the prospective customer from the customer information storage unit, acquires the transaction history with the prospective customer from the transaction history storage unit and by accessing the transaction condition storage unit, determines the transaction conditions corresponding to the credit information and the transaction history of the prospective customer, and wherein the transaction condition transmission unit transmits the transaction conditions determined by the transaction condition determining unit to the order terminal.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates an embodiment;

FIG. 2 illustrates an exemplary system configuration according to an embodiment;

FIG. 3 illustrates order processing work;

FIG. 4 illustrates an exemplary hardware configuration of the sales management server according to an embodiment;

FIG. 5 illustrates a sales management server;

FIG. 6 illustrates an exemplary data structure of the customer information DB;

FIG. 7 illustrates an exemplary data structure of the pending-order management information DB;

FIG. 8 illustrates an exemplary data structure of the commodity DB;

FIG. 9 illustrates an exemplary data structure of the work flow DB;

FIG. 10 illustrates an exemplary data structure of the transaction condition storage unit;

FIG. 11 an exemplary order reception to order conclusion;

FIG. 12 illustrates an order reception process;

FIG. 13 illustrates a price confirmation process;

FIG. 14 illustrates a credit confirmation process;

FIG. 15 illustrates a approval process;

FIG. 16 illustrates an order acceptance process;

FIG. 17 illustrates an exemplary pending-order management screen;

FIG. 18 illustrates an exemplary price confirmation screen;

FIG. 19 illustrates an exemplary credit confirmation screen; and

FIG. 20 illustrates an exemplary approval screen.

### DETAILED DESCRIPTION OF THE EMBODIMENTS

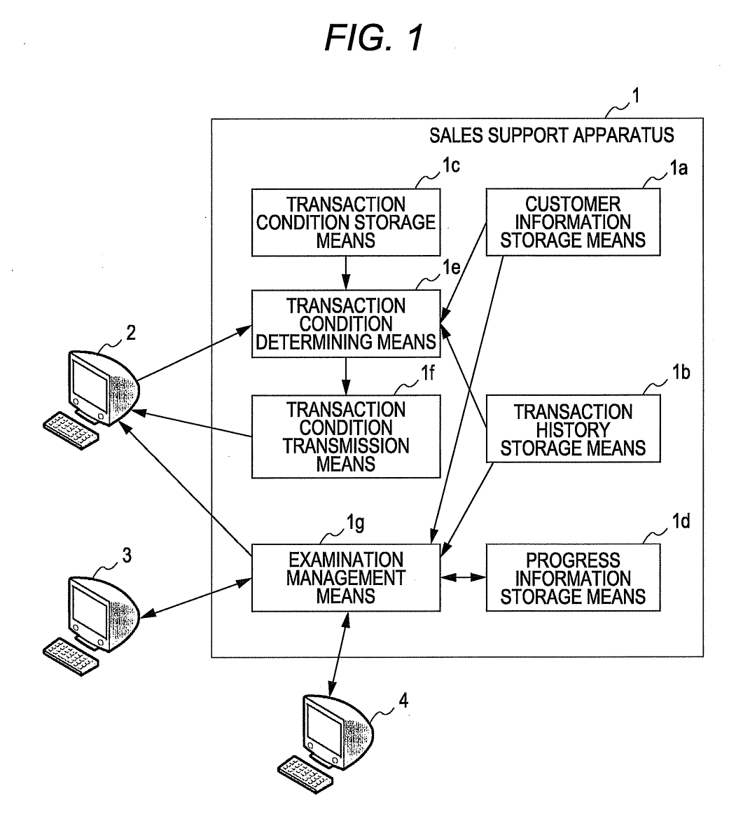

FIG. 1 illustrates a sales support apparatus 1 including a customer information storage unit 1a, a transaction history storage unit 1b, a transaction condition storage unit 1c, a progress information storage unit 1d, a transaction condition determining unit 1e, a transaction condition transmission unit 1f and an examination management unit 1g.

The customer information storage unit 1a stores the credit information of the customers. The credit information may be digital evaluation points indicating the credit standing of each customer.

The transaction history storage unit 1b stores the history of the past transactions with each customer. The number of the past transactions with each customer may be known from the transaction history. In addition to the past transaction information indicating the contents of the past transactions, the transaction history storage unit 1b has stored therein the transaction history in the form of the in-examination pending-order information waiting for approval for the transaction for the received order.

The transaction condition storage unit 1c stores therein the transaction conditions corresponding to the combination between the credit information and the transaction history of the customer. The transaction condition storage unit 1c may have set therein the discount rate as a transaction condition which assumes a higher value the higher the credit standing based on the credit information or the greater the number of past transactions.

The progress information storage unit 1d stores the confirmation state indicating whether the in-examination pending-order information is confirmed or not. The confirmation state may be used where the in-examination pending-order information is approved after confirmation of the contents thereof by the person in charge of confirmation (hereinafter referred to as the confirmation person).

The transaction condition determining unit 1e, upon application thereto of a transaction condition acquisition request designating the prospective customer company from the order terminal, acquires the credit information of the prospective customer company from the customer information storage unit 1a. The transaction condition determining unit 1e acquires the history of transactions with the prospective customer company from the transaction history storage unit 1b. The transaction condition determining unit 1e determines the transaction conditions corresponding to the transaction history and the credit information of the prospective customer company by referring to the transaction condition storage unit 1c.

The transaction condition transmission unit 1f transmits the transaction conditions determined by the transaction condition determining unit 1e to the order terminal.

The examination management unit 1g transmits the in-examination pending-order information of the prospective customer company, the credit information of the prospective customer company and the past transaction information of the prospective customer company to the approval terminal 4 used by the person in charge of approval (hereinafter referred to as the approval person). The examination management unit 1g, upon reception of the approval information indicating the approval of the transactions from the approval terminal 4, transmits the approved in-examination pending-order information to the order terminal 2.

Once the in-examination pending-order information is approved after confirmation of the contents thereof by the person in charge of confirmation (hereinafter referred to as the confirmation person), the examination management unit 1g transmits the in-examination pending-order information of the prospective customer company, the credit information of the prospective customer company and the past transaction information of the prospective customer company to the confirmation terminal 3 used by the confirmation person to confirm the contents of the in-examination pending-order information. The examination management unit 1g, upon reception of the confirmation information indicating the completion of confirmation from the confirmation terminal 3, sets the progress information of the in-examination pending-order information in the progress information storage unit 1d as “confirmed”. The examination management unit 1 transmits the in-examination pending-order information in the “confirmed” state to the approval terminal.

In this sales support apparatus, upon application of the transaction condition acquisition request from the order terminal, the transaction conditions corresponding to the credit information and the transaction history of the prospective customer company may be determined, and the transaction conditions thus determined are transmitted to the order terminal. Where the contents of the pending order of which the transaction conditions are established are to be confirmed or approved, the in-examination pending-order information is transmitted to the confirmation terminal 3, and the in-examination pending-order information for which the confirmation information has been received is transmitted to the approval terminal 4. Upon reception of the approval information from the approval terminal 4, the approved in-examination pending-order information is transmitted to the order terminal 2.

As described above, the information required before investigation and examination are computerized thereby to reduce the burden on the sales person. By managing the confirmation progress situation by unit of the progress information, each approval and the confirmation of the transaction contents by the various departments may be quickly carried out. The response to the customer is quickened, thereby preventing the sales chance from being lost.

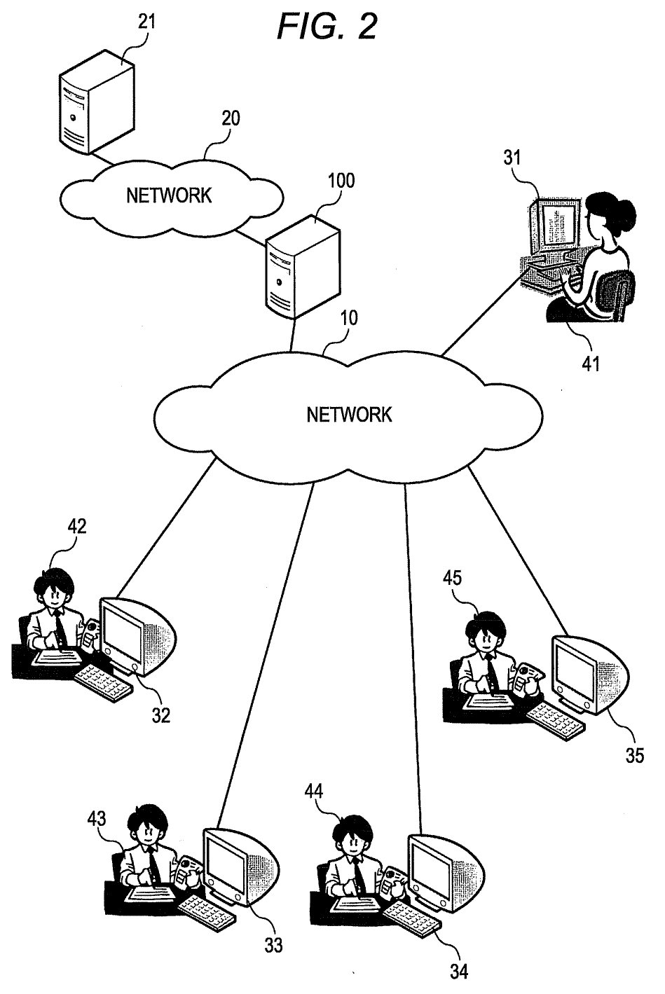

FIG. 2 illustrates an exemplary system configuration according to an embodiment. According to an embodiment, the order management in the commodity distributor is carried out using a sales management server 100.

The sales management server 100 may be connected to a credit information providing server 21 through a network 20. The credit information providing server 21 is installed in a credit bureau providing the credit information of companies. The credit information of each company investigated by the credit bureau are accumulated in the credit information providing server 21. The credit information include the size, the number of employees, capital amount, proceeds, profits and the account closing time of each company.

The sales management server 100 acquires the credit information of a company periodically from the credit information providing server 21. The credit information thus acquired are held in time series. The credit information thus held are retrievable. Although only one credit information providing server 21 is illustrated in FIG. 2, the credit information may alternatively be acquired from each of plural credit information providing servers of different credit bureaus and centrally managed. The sales management server 100 automatically acquires the credit information each time it is updated by the credit information providing server 21.

The user can write additional data in the credit information managed by the sales management server 100. The credit standing may be changed or the number of retrievals may be recorded by actually investigating the company involved. By updating the information appropriately in accordance with the latest information in this way, highly reliable credit information may be obtained.

The sales management server 100 may be connected with plural client terminals 31 to 35 through a network 10. The network 10 is, for example, the in-house intranet. The client terminals 31 to 35 are terminal units allowing the employees of the distributor to access the sales management server 100. In the case of FIG. 2, for example, the client terminal 31 is used by the sales person 41, and the client terminal 32 by a person 42 in charge of price (hereinafter referred to as the pricing person 42), the client terminal 33 by the accounting person 43, the client terminal 34 by the manager 44 and the client terminal 35 by the person 45 in charge of commodity distribution.

The sales person 41 may answer the telephone at a call center for receiving orders from customers. The pricing person 42 may determine the commodity price and register it in the sales management server 100. The accounting person 43 may determine the credit standing of each customer. The term “credit” is defined as a value indicating the credit standing of a company. The manager 44 may be authorized to grant the approval on the sale of the commodity to the customer and engaged in the job of judging whether the commodity is to be sold or not. The person 45 in charge of commodity distribution may register the commodity production schedule and stock state in the sales management server 100.

The sales management server 100, by conducting communication with the client terminals 31 to 35, confirms and approves the contents of the pending order on the electronic data. Each user can easily transfer the required information to his/her senior person (for example, the manager) responsible for approval. The person responsible for approval confirms the information while viewing the screen on the data base. By managing this data exchange, the delivery of paper documents or other bottlenecks such as a limited working place may be obviated from the normal job practice. The communication can use the technique based on Web.

For some companies, the person responsible for approval and the accounting department are separate from each other. To meet such a situation flexibly, the sales management server 100 can register therein the individual person responsible for approval and the existence or nonexistence of an accounting department with respect to each user.

In the case where the confirmation from plural departments is required, the confirmation progress is required to be managed. A sales management server 100 may manage the work flow. The sales management server 100 records the information on the progress of the data communication between the user and the person responsible for approval or the accounting department as a work flow. The progress of the confirmation and approval of each pending order is clarified so that the confirmation and approval job may be performed quickly. The sales management server 100, at the time of confirmation or approval, transmits the credit information and other information such as the number of transactions of the customer company with the distributor to the client terminals of the persons in charge. In this way, the confirmation and approval job is also facilitated.

The sales management server 100 has recorded therein the contents of the past transactions as a history. The status of each pending order and the past history may be accessed, thereby eliminating the need of the wasteful investigation of the corporate information and filing of applications. Also, for some companies which experience variations of business achievement, the corporate examination is simplified based on the past history and the information on the past variations are referred to in the sales negotiations.

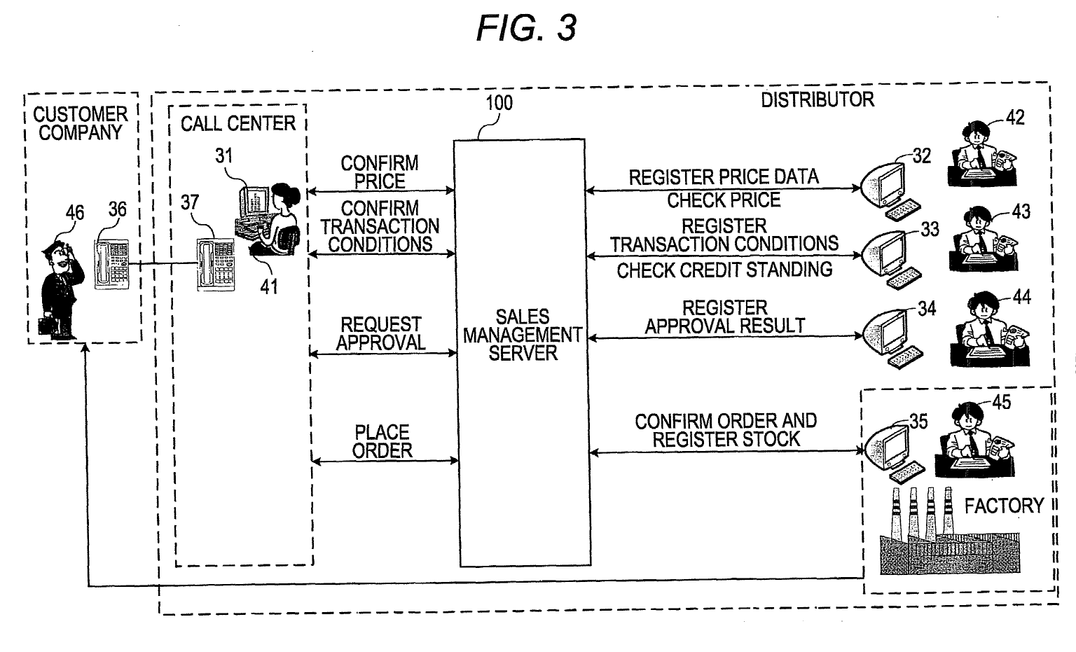

Operations after reception of an order from a customer are explained. FIG. 3 is a diagram showing the order processing work. In this system, the pricing person 42 registers the commodity price data in the sales management server 100 in advance using the client terminal 32. The accounting person 43 registers the transaction conditions in the sales management server 100 in advance using the client terminal 33.

The person 46 in charge of the ordering (hereinafter referred to as the ordering person 46) in the customer company places an order by phoning the call center on the telephone 36. The sales person 41 of the call center answers the phone 37. The person picks up the name of the customer company and the specifics of the order from the ordering person 46. Examples of the order specifics include the commodity and the quantity.

The sales person 41 who has grasped the order specifics accesses the sales management server 100 using the client terminal 31 and confirms the price of the ordered commodity and the transaction conditions. The transaction conditions may be determined by the sales management server 100 in accordance with the credit information, the past number of transactions and the current transaction amount of the customer company. The sales person 41 negotiates with the ordering person 46 about the price and quantity within the range of the transaction conditions. Once the negotiation is concluded, the sales person 41 inputs the established order specifics to the sales management server 100 using the client terminal 31.

The established order specifics are displayed at the client terminal 32, and the pricing person 42 checks the price. The pricing person 42, upon judgment that the sales price has no problem, inputs the information indicating the completion of the price confirmation to the sales management server 100 using the client terminal 32.

Upon complete price confirmation, the order specifics including the credit information are displayed at the client terminal 33, and the accounting person 43 checks the credit. The accounting person 43 judges whether the sale is possible or not based on the credit standing of the customer company and the selling risk (the sales amount and the time of price collection). Once the accounting person 43 judges that the sale is possible, the information indicating the completion of the credit confirmation is input to the sales management server 100 using the client terminal 33.

Upon completion of credit confirmation, the order specifics are displayed at the client terminal 34, and the manager 44 judges whether the proposed sale is to be approved or not. In the case where the sale is approved, the manager 44 inputs the information indicating the approval to the sales management server 100 using the client terminal 34.

Once the sale is approved, the approval result is displayed at the client terminal 31. The sales person 41 contacts the ordering person 46 of the customer company by phone and notifies that the order on which both parties have agreed has been approved. The sales person 41 confirms that the ordering 46 has no intention to cancel the order, and thus the transactions are established.

Once the transactions are established successfully, the sales person 41 accesses the sales management server 100 using the client terminal 31 and sets the established order as accepted. The person 45 in charge of commodity distribution accesses the sales management server 100 using the client terminal 35 and acquires the information on the accepted order. The person 45 in charge of commodity distribution adjusts the schedule for factory production of the commodity and ships the commodity to the customer company from the factory.

The information required to process the order in the operations described above are managed centrally in the sales management server 100.

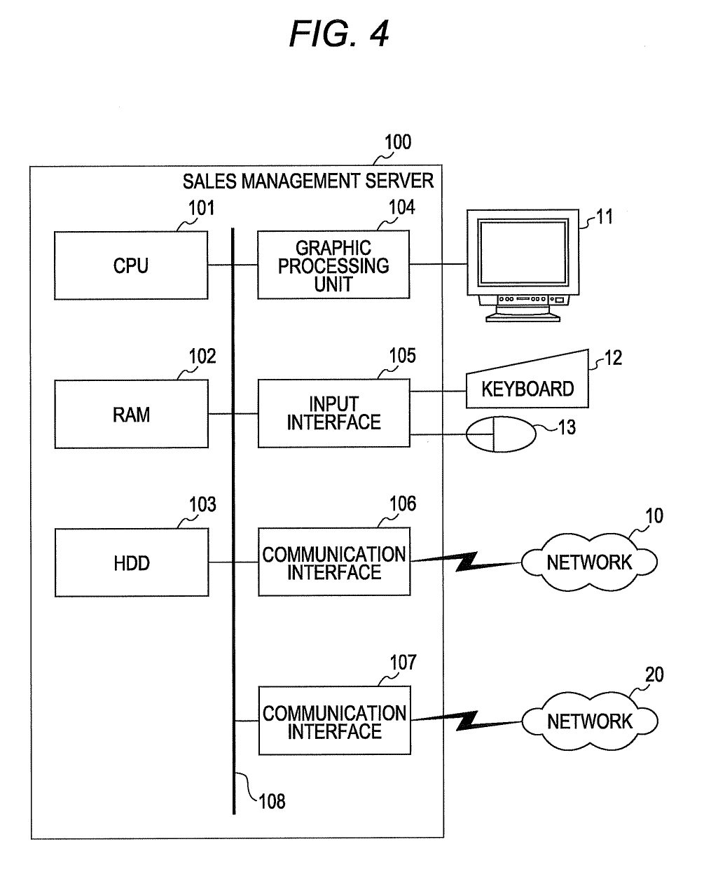

FIG. 4 illustrates an exemplary hardware configuration of the sales management server 100 according to an embodiment. The sales management server 100 is controlled in its entirety by a CPU (central processing unit) 101. The CPU 101 may be connected with a RAM (random access memory) 102, a hard disk drive (HDD) 103, a graphic processing unit 104, an input interface 105 and communication interfaces 106, 107 through a bus 108.

The RAM 102 is used as a main storage unit of the sales management server 100. The RAM 102 temporarily stores at least a part of the application program and the program of the operating system (OS) executed by the CPU 101. The RAM 103 stores the various data required for the process executed by the CPU 101. The HDD 103 is used as a secondary storage unit of the sales management server 100. The HDD 102 has stored therein the OS program, the application program and various data. Incidentally, a semiconductor storage device such as a flash memory may be used as a secondary storage unit.

The graphic processing unit 104 may be connected with a monitor 11. The graphic processing unit 104 displays the image on the screen of the monitor 11 in accordance with the instruction from the CPU 101. The monitor 11 may be a display unit using the CRT (cathode ray tube) or a liquid crystal display unit.

The input interface 105 may be connected with a keyboard 12 and a mouse 13. In the input interface 105, the signal input from the keyboard 12 or the mouse 13 is transmitted to the CPU 101 through the bus 108. Incidentally, the mouse 13 is only an example of the pointing device, and any of other pointing devices such as the touch panel, tablet, touch pad or the track ball may alternatively be used.

The communication interface 106 may be connected to the network 10. The communication interface 106 is to transmit and receive the data between the client terminals 31 to 35 through the network 10.

The communication interface 107 may be connected to the network 20. The communication interface 107 is to transmit and receive the data to and from the credit information providing server 21 through the network 20.

Although FIG. 4 shows an exemplary hardware configuration of the sales management server 100, the credit information providing server 21 and the client terminals 31 to 35 can also be realized with a similar hardware configuration.

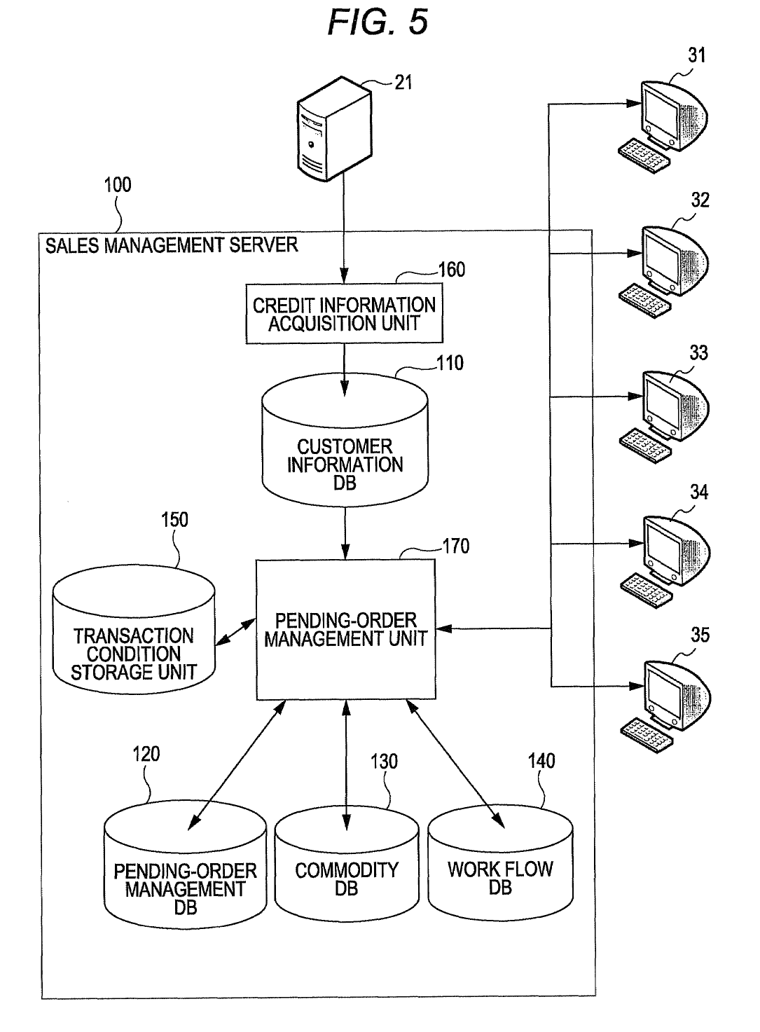

FIG. 5 illustrates a sales management server 100. The sales management server 100 includes a customer information data base (DB) 110, a pending-order management data base (DB) 120, a commodity data base (DB) 130, a work flow data base (DB) 140, a transaction condition storage unit 150, a credit information acquisition unit 160 and a pending-order management unit 170.

The customer information DB 110 stores the credit information of the customer. A part of the storage area of the HDD 103, for example, is used as the customer information DB 110.

The pending-order management unit 120 stores the contents of the pending order. A part of the storage area of the HDD 103, for example, is used as the pending-order management DB 120.

The commodity DB 130 stores the information on the commodity. A part of the storage area of the HDD 103, for example, is used as the work flow DB 130.

The work flow DB 140 stores the information (work flow) indicating the progress of the process on the pending order. A part of the storage area of the HDD 103, for example, is used as the work flow DB 140.

The transaction condition storage unit 150 stores the transaction conditions for negotiations between the sales person 41 and the ordering person 46 of the customer company. A part of the storage area of the HDD 103, for example, is used as the transaction condition storage unit 150.

The credit information acquisition unit 160 periodically acquires the credit information from the credit information providing server 21. The credit information acquisition unit 160 stores the acquired credit information in the customer information DB 110.

The pending-order management unit 170 manages the pending order. The pending-order management unit 170, in response to the input from the client terminals 31 to 35, receives the order, and using the various storages, executes the processes such as the confirmation of the order specifics by the persons in charge at the various related departments and the approval of the order by the manager. In the process, the pending-order management unit 170 can present to the sales person 41 beforehand the sales conditions for smooth execution of all the confirmation and approval based on the credit information and the past transactions of the customer. The sales person 41 can negotiate and come to agreement quickly with the prospective customer within the scope of the indicated sales conditions on the order specifics.

The correspondence a sales support apparatus 1 illustrated in FIG. 1 and a sales management server 100 is described below. The customer information storage may be included in the customer information DB 11. The transaction history storage ay be included in the pending-order management DB 120. The transaction condition storage may be included in the transaction condition storage unit 150. The progress information storage may be included in the work flow DB 140. The transaction condition determining, the transaction condition transmission and the examination management may be included in the pending-order management unit 170.

The data stored in each storage held by the sales management server 100 is disclosed.

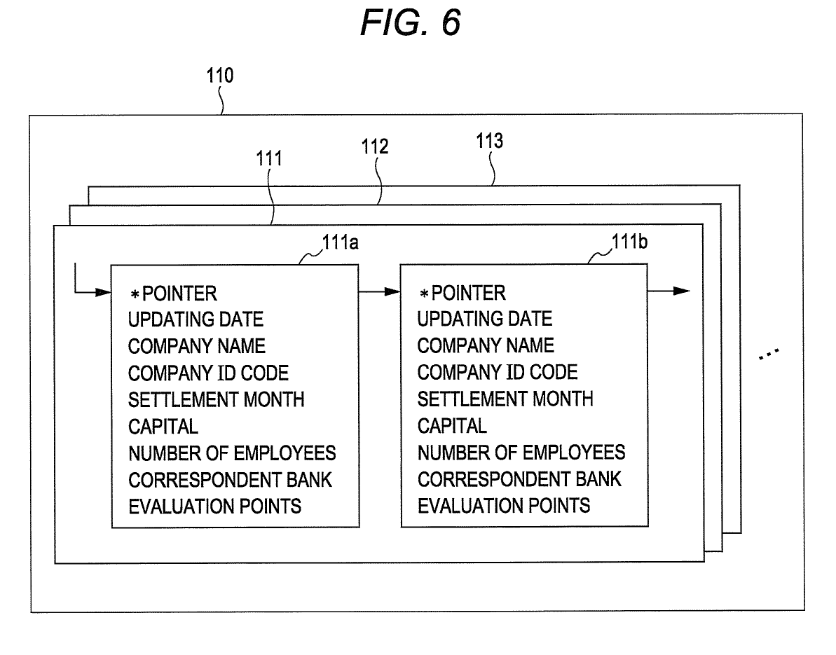

FIG. 6 illustrates an exemplary data structure of the customer information DB. The customer information DB 110 has registered therein the customer information groups 111, 112, 113 and so on, corresponding to the customers. The customer information groups 111, 112, 113 and so on, are each configured of at least one customer information.

In the case of FIG. 6, for example, the customer information group 111 is configured of plural customer information 111a, 111b and so on. The customer information 111a, 111b and so on are stored in the order of acquisition from the credit information providing server 21. The last registered customer information is newest. The customer information 111a, 111b and so on include the fields of the pointer, updating date, company name, company ID code, month of settlement, capital amount, number of employees, correspondent bank and the evaluation points.

The pointer field may have set therein the position information (pointer) indicating the storage place of the next customer information. The updating date field may have set therein the last date when the customer information is updated. The field of the company name may have set therein the name of the customer company. The field of the company ID code may have set therein the identifier (company ID code) for uniquely identifying the customer company in the sales management server 100. The field of the month of settlement may have set therein the month of settlement of the customer company. The field of the capital amount may have set therein the capital fund of the customer company. The field of the number of employees may have set therein the work forces of the customer company. The field of the correspondent bank may have set therein the name of the bank with which the customer company is in transaction. The field of the evaluation points may have set therein the credit standing (evaluation points) of the customer company determined by the credit bureau.

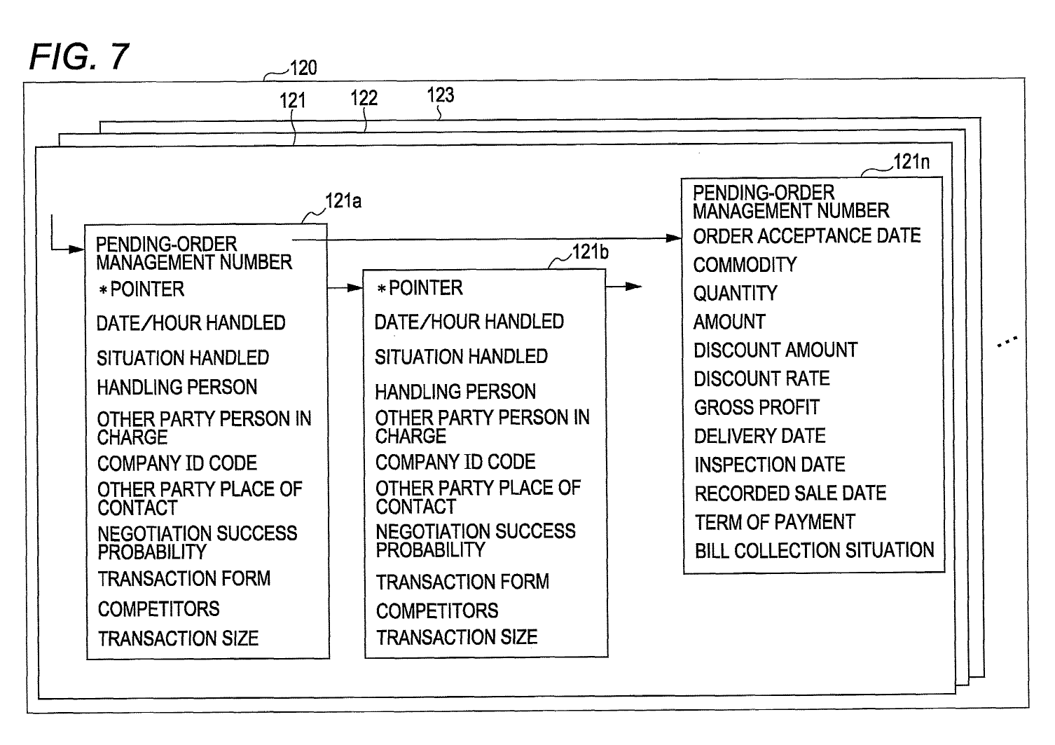

FIG. 7 illustrates an exemplary data structure of the pending-order management DB. The pending-order management DB 120 has registered therein the pending-order information groups 121, 122, 123 and so on, for respective pending orders. The pending-order information groups 121, 122, 123 and so on, are each configured of at least one pending-order information.

In the case illustrated in FIG. 7, for example, the pending-order information group 121 is configured of plural pending-order information 121a, 121b, . . . , 121n. The pending-order information 121a, 121b, . . . , 121n include the pending-order information 121a, 121b and so on, which are under examination, and the pending-order information 121n which is concluded with the order specifics thereof established. In the in-examination pending-order information 121a, 121b and so on, the sales person 41 corresponds to the ordering person 46 of the customer company, and the information are stored in the order of registration of the corresponding specifics. The last pending-order information registered is the latest one.

Of the in-examination pending-order information 121a, 121b, the first one 121a has the fields of pending-order management number, pointer, processed date/hour, process situation, the person engaged, the other party person in charge, company ID code, contact unit of customer, negotiation success probability, transaction form, competitors and sales volume.

The field of the pending-order management number may have set therein the identifier (pending-order management number) for uniquely identifying the pending order. The pointer field may have set therein the position information (pointer) indicating the place of storage of the next pending-order information. The field of the processed date/hour may have set therein the date/hour when the sales person 41 is engaged. The field of the process situation may have set therein the text indicating the contents of the engagement. The field of the person engaged may have set therein the identifier (such as the employee code) for uniquely identifying the engaged sales person 41. The field of the other party person in charge may have set therein the information (associated department, name, etc.) for uniquely identifying the ordering person 46 of the customer company. The field of the company ID code may have set therein the identifier (company ID code) for uniquely identifying the customer company. The field of the contact unit of customer may have set therein the contact unit (such as the telephone number) of the ordering person 46. The field of the negotiation success probability may have set therein the possibility of succeeding in the negotiation as judged by the sales person 41. The field of the transaction form may have set therein the form of transaction such as the settlement in cash or payment after delivery. The field of competitors may have set therein the name of the company(s) selling the competing commodity in the case where the customer company exposes the distributor to the competition with other companies. The field of the sales volume may have set therein the size of the order under transaction (such as the approximate value of the expected order).

The second and subsequent pending-order information 121b and so on before 121n have the fields similar to the pending-order information 121a except for the leading field of the pending-order management number. The pending-order information 121n of the concluded order has the fields of the pending-order management number, ordered date, commodity, quantity, amount, discount, discount rate, gross profit, delivery date, inspection date, recorded sales date, payment terms and collection situation.

The field of the pending-order management number may have set therein the pending-order management number of the pending order. The field of the order acceptance date may have set therein the date at which the agreement is reached on the order specifics. The commodity field may have set therein the name of the commodity ordered. The quantity field may have set therein the quantity ordered. The discount field may have set therein the difference between the total amount of the commodity sold at the standard price and the actual sales price. The field of the discount rate may have set therein the percentage of the discount amount with respect to the total amount sold at the standard price. The field of the gross profit may have set therein the gross profit obtained by the sales (formally, gross income on sales, i.e. the total sales amount subtracting the sales cost). The field of the delivery date may have set therein the date at which the commodity is scheduled to arrive at the customer company. The field of the inspection date may have set therein the date at which the commodity inspection is conducted in the customer company. The field of the recorded sales date may have set therein the date at which the commodity sold is calculated as a sales amount. The field of the terms of payment may have set therein the conditions for price payment such as the term of payment. Incidentally, the term of payment is defined as the lead time from the closing date to the payment date of the transaction amount. The field of the collection situation may have set therein the situation as to whether the price has been collected or not.

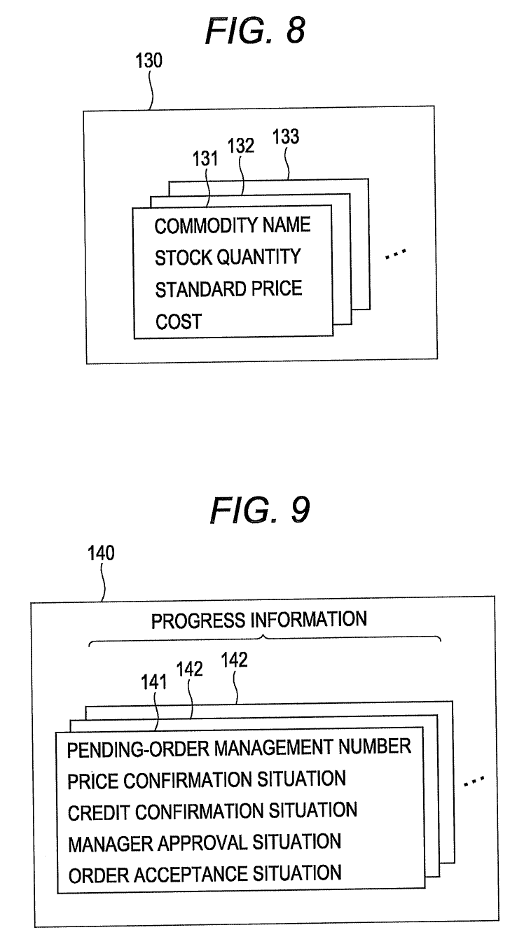

FIG. 8 illustrates an exemplary data structure of the commodity DB 130. The commodity DB 130 has registered therein the commodity information 131, 132, 133 and so on for each commodity. The commodity information 131, 132, 133 and so on each have the fields of the commodity name, stock amount, standard price and cost.

The field of the commodity name may have set therein the name (model number, etc.) of the commodity. The field of the stock amount may have set therein the quantity of the commodity in stock. The field of the standard price may have set therein the standard price (desired retail price) of the commodity.

FIG. 9 illustrates an exemplary data structure of the work flow DB. The work flow DB 140 has registered therein the progress information 141, 142, 143 and so on, for each pending order.

The progress information 141, 142, 143 and so on have set therein the pending-order management number, price confirmation situation, credit confirmation situation, managerial approval situation and the order acceptance situation. The field of the pending-order management number may have set therein the pending-order management number corresponding to the progress information.

The price confirmation situation field may have set therein a flag indicating whether the confirmation of the pending order by the pricing person 42 is complete or not. Where the price confirmation is not yet complete, the value in the price confirmation situation field is “not confirmed”, while in the case where the price confirmation is complete, the value in the price confirmation situation field is “confirmed”.

The credit confirmation situation field may have set therein a flag indicating whether the credit confirmation by the accounting person 43 is complete or not. In the case where the credit confirmation is not yet complete, the value in the credit confirmation situation field is “not confirmed”, while in the case where the credit confirmation is complete, the value in the credit confirmation situation field is “confirmed”.

The managerial approval situation field may have set therein a flag indicating whether the approval by the manager 44 is complete or not. Where the approval is not yet complete, the value in the managerial approval situation field is “not approved”, while in the case where the approval is complete, the value in the managerial approval situation field is “approved”.

The order acceptance situation field may have set therein a flag indicating whether the order is concluded and accepted by the commodity distribution department. In the case where the order is not concluded, the value in the order acceptance situation field is “not yet accepted”, while in the case where the order is concluded, the value in the order acceptance situation field is “accepted”.

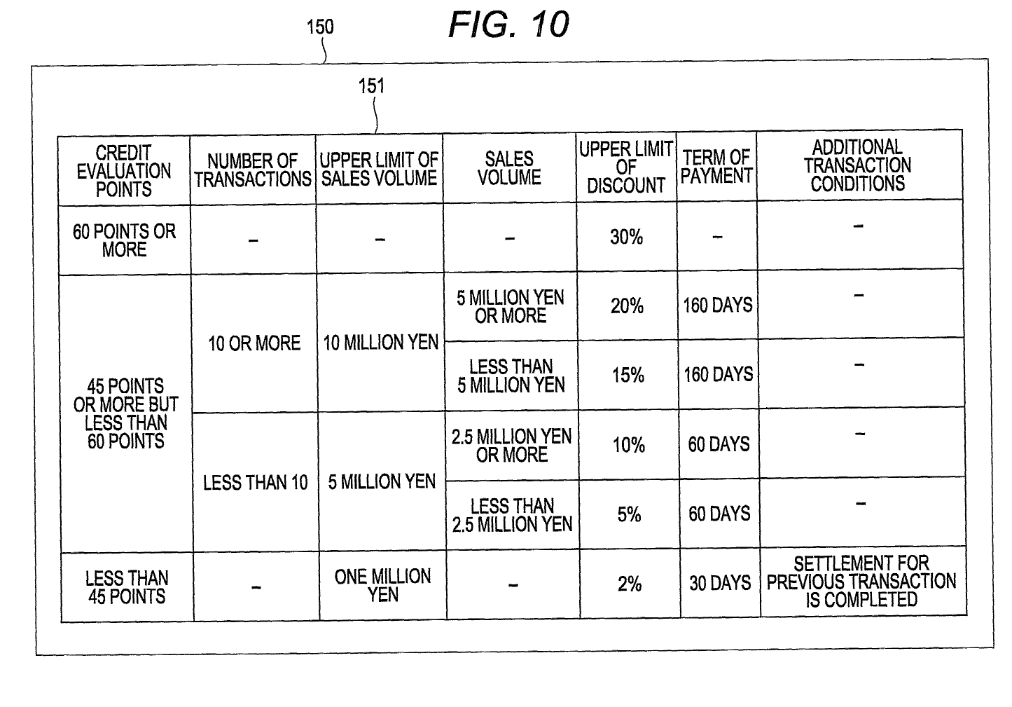

FIG. 10 illustrates an exemplary data structure of the transaction condition storage unit. The transaction condition storage unit 150 stores a transaction condition table 151. The transaction condition table 151 is a data table having registered therein the correspondence between the criteria for determining the transaction conditions and the transaction conditions judged according to each criterion. The transaction condition table 151 may have set therein the fields of credit evaluation points, number of transactions, upper limit value of sales volume, sales volume, upper discount limit, term of payment and the additional transaction conditions.

The field of credit evaluation points may have set therein the range of the evaluation points covered by each transaction condition in the case where the particular transaction condition is determined in accordance with the evaluation points included in the credit information. In the case of FIG. 10, for example, three ranges of evaluation points, i.e. not less than 60, not less than 45 but less than 60, and less than 45 are set.

The field of the number of transactions may have set therein the range of the number of transactions covered by each transaction condition in the case where the particular transaction is determined in accordance with the number of past transactions with the distributor. Incidentally, in the case where the transaction conditions are not determined in accordance with the number of past transactions, the range of the number of transactions is not set. In the case of FIG. 10, for example, the transaction condition corresponding to the number of past transactions is set only in the case where the evaluation points of the credit information is not less than 45 but less than 60. In this case, two ranges, i.e. not less than ten and less than ten are set as a range of the number of transactions for the evaluation points of not less than 45 but less than 60.

The field of the upper limit of the sales volume may have set therein a value corresponding to the credit information evaluation points and the number of transactions. In the case where the upper limit value of the sales volume is already set, the judgment cannot be made only by the sales person 41 whether the order of a size not less than the upper limit of the sales volume may be accepted or not. In the case of an order of the sales volume not more than the upper limit of the sales volume, the judgment as to whether the order is to be accepted or not may be made quickly using the system according to the invention. In the case of FIG. 10, for example, the upper limit of the sales volume is 10 million yen if the evaluation points are not less than 45 but less than 60 and the number of past transactions is not less than ten. The upper limit of the sales volume is five million yen in the case where the evaluation points are not less than 45 but less than 60 and the number of past transactions is less than ten.

The field of the sales volume may have set therein the range covered by each transaction condition in the case where the particular transaction is determined in accordance with the sales volume of the order. Where the transaction condition corresponding to the sales volume is not determined, the range of the sales volume is not set. In the case of FIG. 10, for example, the transaction condition corresponding to the sales volume is set only in the case where the evaluation points of the credit information are not less than 45 points but less than 60 points. In the case under consideration, four ranges of the sales volume, i.e. not less than five million yen, less than five million yen, not less than 2.5 million yen and less than 2.5 million yen are set as the transaction conditions applicable for the evaluation points of not less than 45 but less than 60.

The field of the upper discount limit may have set therein the upper limit of the discount corresponding to the evaluation points of the credit information. The upper discount limit indicates the upper limit of the discount rate which the sales person 41 may be authorized to determine. The orders in keeping with the designation of the range of the evaluation points may be further classified by the number of transactions or the sales volume, so that the upper discount limit value may be set in accordance with the combination of the evaluation points, the number of transactions and the sales volume. In the case of FIG. 10, for example, assuming that the evaluation points are not less than 60, the upper discount value is 30%. Assume, on the other hand, that the evaluation points are not less than 45 but less than 60, the number of transactions is not less than ten and the sales volume is not less than 5 million yen. The upper discount limit value is 20%. In the case where the evaluation points are not less than 45 but less than 60, the number of transactions is not less than 10 and the sales volume is less than 5 million yen, however, the upper discount limit value is 15%. Also, in the case where the evaluation points are not less than 45 but less than 60, the number of transactions is less than 10 and the sales volume is not less than 2.5 million yen, then the upper discount limit value is 10%. Similarly, in the case where the evaluation points are not less than 45 but less than 60, the number of transactions are less than 10 and the sales volume is less than 2.5 million yen, then the upper discount limit value is 5%. In the case where the evaluation points are less than 45, the upper discount limit value is 2%.

The field of the term of payment may have set therein the term of payment corresponding to the evaluation points of the credit information. The orders covered by the designated range of the evaluation points may be further classified by the number of transactions or the sales volume, and the term of payment may be set in accordance with the combination of the evaluation points, the number of transactions and the sales volume. In the case of FIG. 10, for example, assuming that the evaluation points are not less than 45 but less than 60 and the number of transactions is not less than 10, then the term of payment is 160 days. In the case where the evaluation points are not less than 45 but less than 60 and the number of transactions is less than 10, on the other hand, the term of payment is 60 days. In the case where the evaluation points are less than 45, the term of payment is 30 days.

The field of the additional transaction conditions may have set therein the additional transaction conditions in accordance with the evaluation points of the credit information. The orders covered by the designated range of the evaluation points may be further classified by the number of transactions or the sales volume, and the transaction conditions may be set in accordance with the combination of the evaluation points, the number of transactions and the sales volume. In the case of FIG. 10, for example, assuming that the evaluation points are less than 45, the new transaction condition that “the settlement for the previous transactions is required to have been completed” is added.

These transaction conditions make it possible to determine the proper price quickly by judging from the credit standing, the sales volume and the past transactions. In other words, the period of negotiations between the sales person 41 and the ordering person 46 may be shortened.

The transaction condition storage unit 150 can also store a character string indicating the policy of determining the transaction conditions. The policy of determining the transaction conditions illustrated in the transaction condition table 151 is described below.

In the case where the evaluation points of the credit information are 60 or more, the customer may be judged as superior. A superior customer is a company highly evaluated in terms of finance. For a superior company, a high upper discount value is set regardless of the sales volume (number of units) to maintain the smooth future relation. Also, a superior company, being well funded, is judged to have a very low risk of the price being unpaid and a margin of the term of payment may be given.

In the case where the evaluation points of the credit information are not less than 45 but less than 60, the company may be judged as an average one. For an average company, the upper discount rate is increased only in the case where the sales volume is large. The evaluation points for an average company are not so high, and therefore, unless the sales volume is large, the discount amount is set at a middle value from the viewpoint of the gross profit. Also, in the case where the evaluation based on the evaluation points by the credit bureau is average but the transactions with the distributor are not less than a predetermined number, the transaction is favorably treated in terms of the discount rate and the quantity sold at once taking the number of past transactions and the prevailing situation into consideration.

In the case where the evaluation points of the credit information are less than 45, the company involved may be evaluated low in credit rating. The company with a low credit standing may be considered a very risky party of transaction. For such an company, therefore, the upper limit of the sales volume is set at a low level. Due to the low sales volume, the discount rate is also set at a small level in consideration of the gross profit. Some companies low in credit standing, though previously superior, are currently driven into a tight corner financially. For the companies low in credit standing, therefore, the discount rate is kept at a low level and the term of payment in a short period regardless of the number of past transactions. Also, in order to prevent the uncollected amount from accumulating, a new transaction with the company low in credit standing is avoided until the outstanding amount is fully paid.

The process executed by the sales management server 100 will be explained in detail.

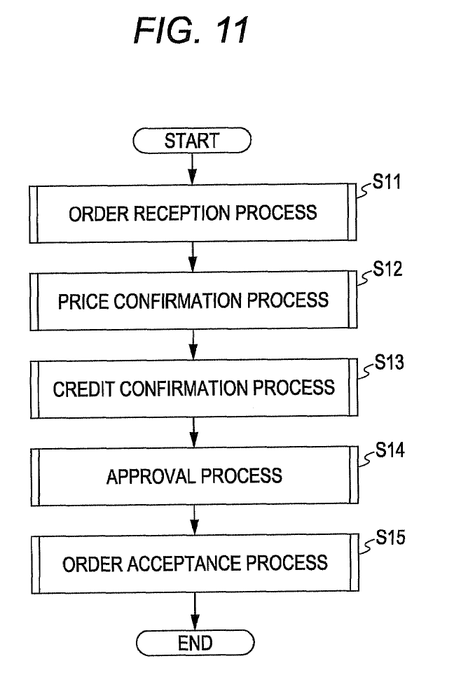

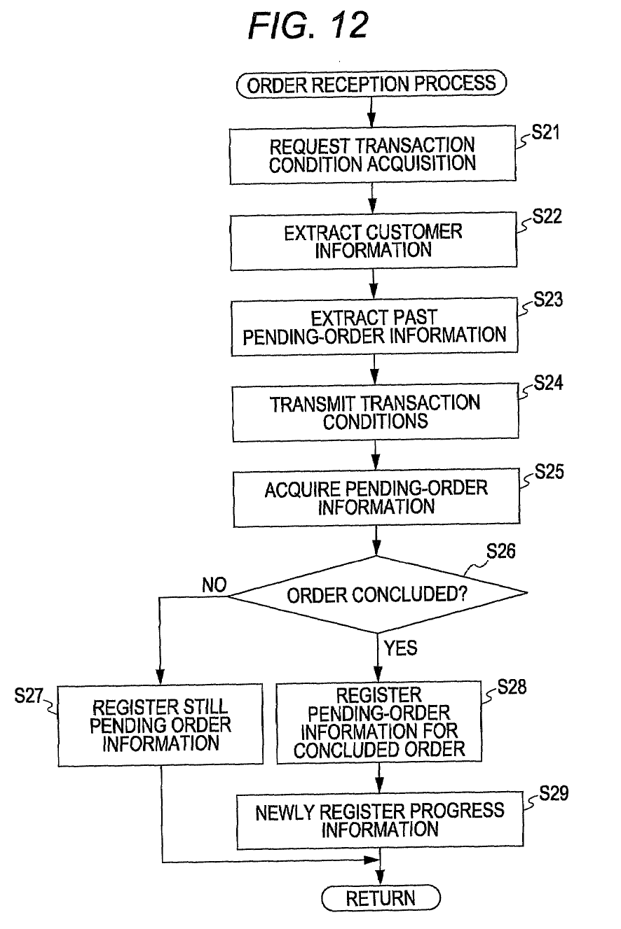

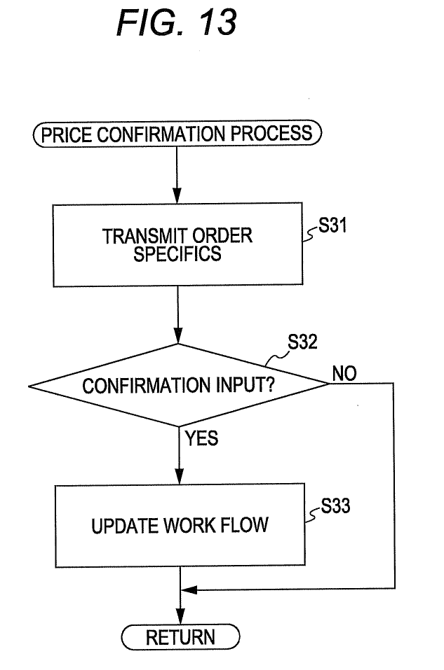

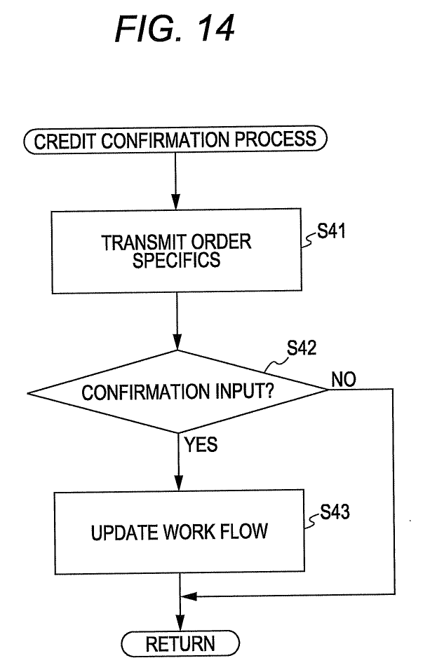

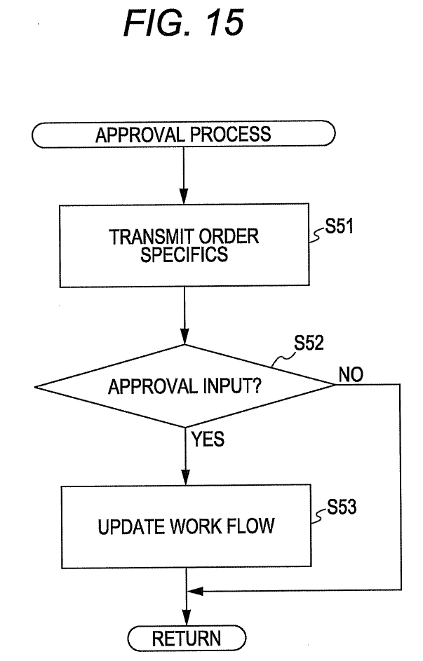

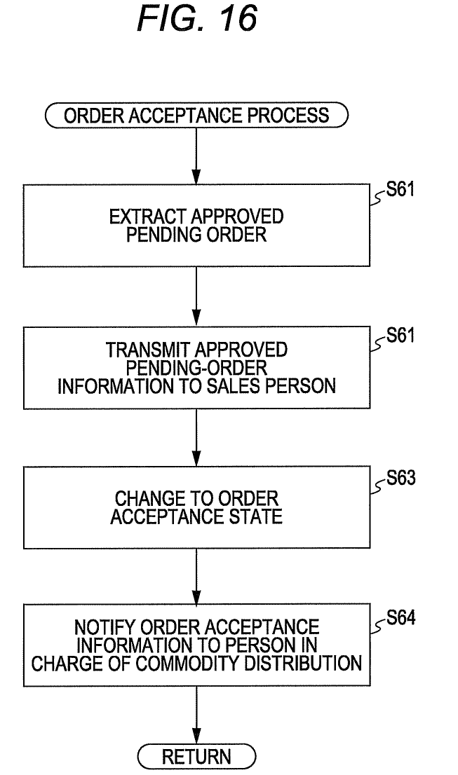

FIG. 11 an exemplary process from the reception to the conclusion of an order. The process illustrated in FIG. 1 is discussed below.

[Operation S11] The sales management server 100 executes the process of receiving the order in collaboration with the client terminal 31 used by the sales person 41 (see FIG. 12).

[Operation S12] The sales management server 100 executes the process of price confirmation in collaboration with the client terminal 32 used by the pricing person 42 (see FIG. 13).

[Operation S13] The sales management server 100 executes the process of credit confirmation in collaboration with the client terminal 33 used by the accounting person 43 (see FIG. 14).

[Operation S14] The sales management server 100 executes the approval process in collaboration with the client terminal 34 used by the manager 44 (see FIG. 15).

[Operation S15] The sales management server 100 executes the order acceptance process in collaboration with the client terminal 31 used by the sales person 41 (see FIG. 16).

FIG. 12 illustrates an order reception process. Now, the process illustrated in FIG. 12 will be explained in the order of operation numbers.

[Operation S21] The pending-order management unit 170 of the sales management server 100 acquires the company name. The sales person 41 receives the phone call from the ordering person 46 of the customer company and picks up the company name and the specifics of the order. The sales person 41 transmits a transaction condition acquisition request including the company name and the order specifics to the sales management server 100 by way of the client terminal 31. In the sales management server 100, the pending-order management unit 170 receives the transaction condition acquisition request.

[Operation S22] The pending-order management unit 170 extracts the customer information corresponding to the company name included in the transaction condition acquisition request from the customer information DB 110.

[Operation S23] The pending-order management unit 170 extracts the past pending-order information corresponding to the company name from the pending-order management DB 120. The pending-order management unit 170 extracts the company ID code from the customer information extracted in operation S22. The pending-order management unit 170 extracts the pending-order information group corresponding to the extracted company ID code from the pending-order management DB 120. In the process, the pending-order information group equal in the number to the past transaction negotiations is extracted. Incidentally, no pending-order information group is extracted in the case where no transaction negotiation has been conducted with the particular prospective customer in the past.

[Operation S24] The pending-order management unit 170 transmits the transaction conditions to the client terminal 31 used by the sales person 41. The pending-order management unit 170 acquires the evaluation points of the customer company based on the customer information extracted in operation S22.

The pending-order management unit 170 determines the number of the past concluded transactions based on the pending-order information group acquired in operation S23. Incidentally, in operation S23, the pending-order information group corresponding to the pending orders negotiated only as a transaction is extracted, and whether they are concluded or not is unclear. Thus, the pending-order management unit 170, searching the work flow DB 140 with the pending-order management number of each extracted pending-order information group, acquires the corresponding progress information. In the case where the order acceptance situation field is set as “order accepted” in the acquired progress information, the pending-order management unit 170 judges that the particular pending order has been concluded. The pending-order management unit 170 sets the number of the received and accepted orders as the number of past transactions.

Further, the pending-order management unit 170 confirms the bill collection situation (settlement completed or not) by referring to the pending-order information after the order agreement in each pending-order information group of the past transactions. In other words, the pending-order management unit 170 judges whether the transactions with the bill not settled still exist or not.

The pending-order management unit 170, referring to the transaction condition table 151 in the transaction condition storage unit 150, determines the transaction conditions based on the information on the customer company (evaluation points, number of transactions, presence or absence of transactions for which the payment is yet to be settled) and the commodity name and quantity included in the order specifics. The pending-order management unit 170 calculates the sales volume based on the order specifics included in transaction acquisition request. In this way, the pending-order management unit 170 acquires the standard price set in the commodity information corresponding to the commodity name by referring to the commodity DB 130. The standard price is multiplied by the quantity thereby to calculate the sales volume. Referring to the transaction condition table 151, the pending-order management unit 170 thus determines the upper limit value of the sales volume, the upper discount limit, the term of payment and the additional transaction conditions corresponding to the evaluation points, number of transactions and the sales volume.

The pending-order management unit 170 transmits each determined condition to the client terminal 31 as a transaction condition. The transaction conditions transmitted include such information as the company name, evaluation points, number of past transactions and the standard price of the commodity involved.

The client terminal 31 displays the pending-order management screen including the acquired transaction conditions. The sales person 41 negotiates with the ordering person 46 of the customer company about the specifics of the accepted order within the range of the transaction conditions on display. The sales person 41 transmits the pending-order information indicating the result of the negotiation to the sales management server 100 using the client terminal 31. Once the order specifics may be determined by negotiations, the information indicating the order conclusion (the order acceptance date, for example) is included in the pending-order information.

[Operation S25] The pending-order management unit 170 of the sales management server 100 acquires the pending-order information transmitted from the client terminal 31. The pending-order management unit 170 registers the acquired pending-order information in the pending-order management DB 120.

[Operation S26] The pending-order management unit 170 judges whether the order is concluded or not. Where the acquired pending-order information contains the information indicating the order conclusion, the pending-order management unit 170 judges that the order is concluded (concluded pending order). Once the order is concluded, the process proceeds to operation S28. In the case where the acquired pending-order information contains no information indicating the order conclusion, on the other hand, the pending-order management unit 170 judges that the order is yet to be concluded (still pending). If the order is not concluded, the process proceeds to operation S27.

[Operation S27] The pending-order management unit 170 registers the pending-order information yet to be concluded in the pending-order management DB 120. The pending-order management unit 170 first judges whether the acquired pending-order information represents a new order or not according to whether the pending-order management number is attached thereto.

If a pending-order number is not so attached, the order is determined to be new, and the pending-order management unit 170 generates a new pending-order management number and stores the pending-order information with the newly generated pending-order management number in the pending-order management DB 120. The order to which the pending-order management number is attached is now under negotiation, and the pending-order management unit 170 registers the last pending-order information acquired in the pending-order information group with the same pending-order management number attached as the acquired pending-order information. The pointer field of the pending-order information just registered may have set therein the position information indicating the place of storage of the currently registered pending-order information and the order reception process may end.

[Operation S28] The pending-order management unit 170 registers the pending-order information of the concluded order in the pending-order management DB 120.

[Operation S29] The pending-order management unit 170 generates the progress information and newly registers it in the work flow DB 140. The pending-order management unit 170 attaches the pending-order management number included in the pending-order information of the concluded order and generates the progress information with the price confirmation situation “unconfirmed”, the credit confirmation situation “unconfirmed”, the manager approval situation “unconfirmed” and the order acceptance situation “not yet accepted”. The pending-order management unit 170 stores the generated progress information in the work flow DB 140. After that, the order reception process may end.

FIG. 13 illustrates a price confirmation process. The explanation below is made about the process illustrated in FIG. 13 in the order of operation number.

[Operation S31] The pending-order management unit 170 of the sales management server 100 transmits the specifics of the concluded order with the price not yet confirmed to the client terminal 32 of the pricing person 42. The pricing person 42 transmits a pending-order information acquisition request for the order with the unconfirmed price to the sales management server 100 using the client terminal 32. The pending-order management unit 170 of the sales management server 100 extracts the pending-order information of the concluded order from the pending-order management DB 120. Further, the pending-order management unit 170 accesses the corresponding progress information in the work flow DB 140 based on the pending-order management number of the pending-order information extracted. The pending-order management unit 170 determines, as an order with the price unconfirmed, the pending-order information with the price confirmation situation “unconfirmed” in the progress information.

In the process, the pending-order management unit 170 acquires the latest customer information for the order with the unconfirmed price from the customer information DB 110, while at the same time counting the number of past transactions based on the pending-order information group of the order with the unconfirmed price by reference to the pending-order management DB 120. The pending-order management unit 170 transmits the pending-order information on the order with the unconfirmed price, the customer information for the pending-order (for example, the company name and the evaluation points) and the number of transactions to the client terminal 32. At the client terminal 32, the contents of the pending-order information sent from the sales management server 100 are displayed on the price confirmation screen.

The pricing person 42 judges whether the sales price is proper or not based on the price confirmation screen displayed at the client terminal 32. In the case where the sales price is proper, the pricing person 42 inputs the completion of the price confirmation to the client terminal 32. The client terminal 32, in response to the input operation from the pricing person 42, transmits the price confirmation information indicating the completion of the price confirmation (including the pending-order management number) to the sales management server 100.

[Operation S32] The pending-order management unit 170 of the sales management server 100 judges whether the price confirmation information is input from the client terminal 32 or not. In the case where the price confirmation information is so input, the process proceeds to operation S33. In the case where the price confirmation information is not input, on the other hand, the price confirmation process may end. The absence of the input of the price confirmation information is, for example, a case in which the price confirmation screen is closed without input operation indicating the completion of the price confirmation.

[Operation S33] The pending-order management unit 170 updates the progress information in the work flow DB 140. The pending-order management unit 170, based on the pending-order management number included in the price confirmation information, searches for the progress information of the pending order of which the price confirmation is completed in the work flow DB 140. The pending-order management unit 170 updates the price confirmation situation of the corresponding progress information as “confirmed”. After that, the price confirmation process may end.

FIG. 14 illustrates a credit confirmation process. The explanation is given below about the process of FIG. 14 in the order of the operation number.

[Operation S41] The pending-order management unit 170 of the sales management server 100 transmits the specifics of the concluded order with the credit confirmation not completed to the client terminal 33 of the accounting person 43. The accounting person 43 transmits a pending-order information acquisition request of the order with the credit not confirmed to the sales management server 100 using the client terminal 33. The pending-order management unit 170 of the sales management server 100 extracts the pending-order information of the concluded order from the pending-order management DB 120. Further, the pending-order management unit 170 accesses the corresponding progress information in the work flow DB 140 based on the pending-order management number of the extracted pending-order information. The pending-order management unit 170 determines, as an order with the credit not confirmed, the pending-order information with the credit confirmation situation “not confirmed” in the progress information.

The pending-order management unit 170 acquires, from the customer information DB 110, the latest customer information of the order with the credit not confirmed, while at the same time counting the number of past transactions based on the pending-order information group of the order with the credit not confirmed, by reference to the pending-order management DB 120. The pending-order management unit 170 transmits the pending-order information of the order with the credit not confirmed, the customer information for the corresponding pending order (such as the company name and the evaluation points) and the number of transactions to the client terminal 33. At the client terminal 33, the contents of the pending-order information transmitted from the sales management server 100 are displayed on the credit confirmation screen.

The accounting person 43, based on the credit confirmation screen displayed at the client terminal 33, judges whether the credit standing of the customer company for the order specifics is proper or not. In the case where the credit standing is proper, the accounting person 43 performs the input operation indicating the completion of the credit confirmation to the client terminal 33. The client terminal 33, in response to the input operation from the accounting person 43, transmits the credit confirmation information (including the pending-order management number) indicating the completion of the credit confirmation to the sales management server 100.

[Operation S42] The pending-order management unit 170 of the sales management server 100 judges whether the credit confirmation information is input from the client terminal 33 or not. In the case where the credit confirmation information is input, the process is passed to operation S43, while no credit confirmation information is input, the credit confirmation process may end. The absence of the input of the credit confirmation information is, for example, a case in which the credit confirmation screen is closed without any input operation indicating the completion of the credit confirmation.

[Operation S43] The pending-order management unit 170 updates the progress information in the work flow DB 140. The pending-order management unit 170, based on the pending-order management number contained in the credit confirmation information, retrieves the progress information for the pending order for which the credit confirmation is completed in the work flow DB 140. The pending-order management unit 170 updates the credit confirmation situation of the corresponding progress information as “confirmed”. After that, the credit confirmation process may end.

FIG. 15 illustrates an approval process. The process illustrated in FIG. 15 will be explained below in the order of the operation number.

[Operation S51] The pending-order management unit 170 of the sales management server 100 sends the specifics of the concluded order with the approval not yet completed to the client terminal 34 of the manager 44. The manager 44, using the client terminal 34, transmits a pending-order information acquisition request with the order not approved, to the sales management server 100. The pending-order management unit 170 of the sales management server 100 extracts the pending-order information of the concluded order from the pending-order management DB 120. Further, the pending-order management unit 170 accesses the corresponding progress information in the work flow DB 140 based on the pending-order management number of the pending-order information thus extracted. The pending-order management unit 170 determines, as an unapproved order, the pending-order information with the managerial approval situation “unapproved” in the progress information.

In the process, the pending-order management unit 170 acquires the latest customer information of the unapproved order from the customer information DB 110, while at the same time counting the number of past transactions based on the pending-order information group of the unapproved order by reference to the pending-order management DB 120. The pending-order management unit 170 transmits the pending-order information of the unapproved order, the customer information (such as the company name and the evaluation points) of the particular pending-order information and the number of transactions to the client terminal 34. At the client terminal 34, the contents including the pending-order information sent from the sales management server 100 are displayed on the approval screen.

The manager 44 judges the permissibility of the sale corresponding to the order specifics based on the approval screen displayed at the client terminal 34. In the case where the sale is permitted, the manager 44 performs the input operation indicating the approval completion to the client terminal 34. The client terminal 34, in response to the input operation from the manager 44, transmits the approval information (including the pending-order management number) indicating the approval completion to the sales management server 100.

[Operation S52] The pending-order management unit 170 of the sales management server 100 judges whether the approval information is input or not from the client terminal 34. In the case where the approval information is so input, the process proceeds to operation S53. In the case where the approval information is not so input, on the other hand, the approval process may end. The absence of the approval information input is a case, for example, in which the approval screen is closed without the input operation indicating the approval completion.

[Operation S53] The pending-order management unit 170 updates the progress information in the work flow DB 140. The pending-order management unit 170, based on the pending-order management number included in the approval information, retrieves the progress information of the pending order with the approval completed in the work flow DB 140. The pending-order management unit 170 updates the approval situation of the corresponding progress information as “approved”. After that, the approval process may end.

The order acceptance process will be explained in detail.

FIG. 16 illustrates an order acceptance process. The process illustrated in FIG. 16 will be explained below according to an operation number.

[Operation S61] The pending-order management unit 170 of the sales management server 100 extracts the approved pending order. The pending-order management unit 170 periodically retrieves the progress information with the managerial approval situation “approved” from the work flow DB 140. The pending-order management unit 170 retrieves the pending-order information group corresponding to the pending-order management number of the progress information found by the search from the pending-order management DB 120.

[Operation S62] The pending-order management unit 170 transmits the contents of the approved pending order to the client terminal 31 used by the sales person 41. The information on the approved pending order is displayed at the client terminal 31.

The sales person 41 contacts the ordering person 46 of the customer for the approved pending order and notifies that the order is concluded. The sales person 41, in consultation with the ordering person 46, determines the information required for delivery such as commodity delivery date. The sales person 41 inputs the information required for delivery using the client terminal 31. The input information is transmitted to the sales management server 100 from the client terminal 31.

[Operation S63] The pending-order management unit 170 of the sales management server 100 sets the concluded pending-order information as accepted. The pending-order management unit 170, based on the information (including the pending-order management number) indicating the order conclusion sent from the client terminal 31, sets the order acceptance situation of the corresponding progress information in the work flow DB 140 as “accepted”.

[Operation S64] The pending-order management unit 170 notifies the accepted pending-order information to the person 45 in charge of commodity distribution. The person 45 in charge of commodity distribution transmits an order acceptance confirmation request to the sales management server 100 using the client terminal 35. The pending-order management unit 170 of the sales management server 100, in response to the order acceptance confirmation request, acquires the progress information set as accepted from the work flow DB 140. The pending-order management unit 170, based on the pending-order management number of the corresponding progress information, acquires the corresponding customer information group and the pending-order information group from the customer information DB 110 and the pending-order management DB 120, respectively. The pending-order management unit 170 extracts, from the acquired information, the information (the company ID code, the unit of contact with the customer, commodity, quantity, delivery date, etc.) required for commodity shipment to the customer company from the factory or warehouse. The pending-order management unit 170 transmits the extracted information to the client terminal 35 used by the person 45 in charge of commodity distribution.

The client terminal 35 displays the received information. The person 45 in charge of commodity distribution, based on the information displayed at the client terminal 35, issues an instruction to produce the product in the factory or make the arrangement for commodity shipment from the warehouse.

As described above, the pending order with the order specifics concluded by the sales person 41 may be efficiently approved. Screens displayed at the client terminal 31 to 34 from a conclusion of the order specifics to an approval are discussed.

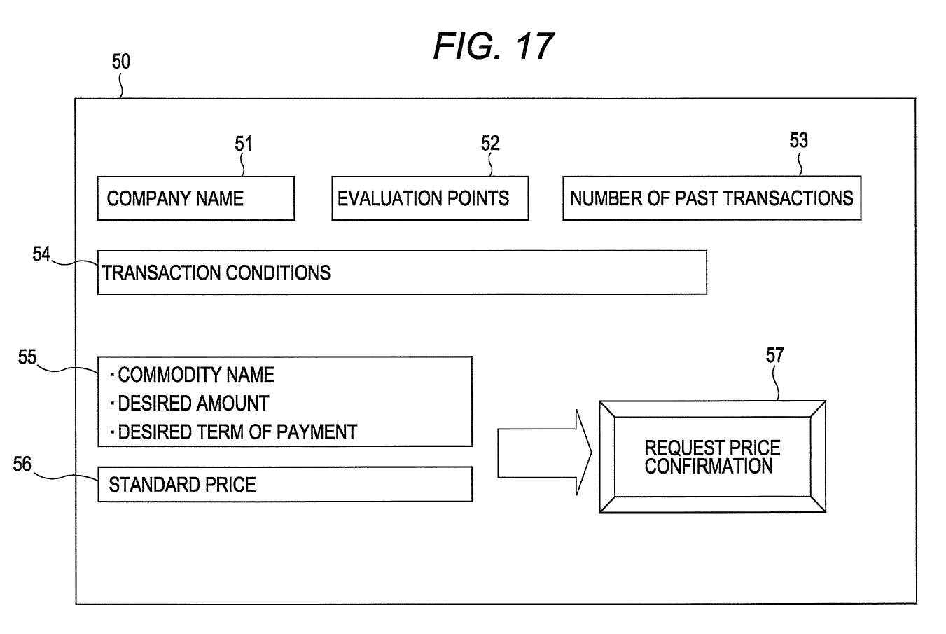

FIG. 17 illustrates an exemplary pending-order management screen. The pending-order management screen 50 is displayed at the client terminal 31 when the sales person 41 conducts negotiations with the ordering person 46 of the customer company. The pending-order management screen 50 includes a company name display section 51, an evaluation point display section 52, a transaction number display section 53, a transaction condition display section 54, an order specifics input section 55, a standard price display section 56 and a price confirmation request button 57.

The company name display section 51 displays the name of the customer company desirous of purchasing the commodity. The evaluation point display section 52 displays the evaluation points of the customer company as determined by the credit bureau. The transaction number display section 53 displays the number of the pending orders transacted by the customer company with the distributor in the past. The transaction condition display section 54 displays the transaction conditions determined in accordance with the evaluation points and the number of past transactions of the customer company.

The order specifics input section 55 is a text input region for inputting the order specifics. The name of the commodity which the customer company requests to purchase, the amount desired by the customer and the term of payment desired by the customers are input as an example. The values input as the desired amount and the desired term of payment are not those simply desired by the customer but those determined by the negotiations between the sales person 41 and the ordering person 46 of the customer company. The order specifics input section 55 may have set therein, in addition to the contents displayed in FIG. 17, the various information required for order conclusion (such as the pending-order information 121a, 121b, . . . , 121n of the concluded order illustrated in FIG. 7). The standard price display section 56 displays the standard price of the commodity to be sold.

The price confirmation request button 57 may be used for requesting the pricing person 42 to confirm the price when the order specifics are concluded. Upon depression of the price confirmation request button 57, the pending-order information with the order specifics concluded is transmitted from the client terminal 31 to the sales management server 100. The pending-order information for the concluded order is displayed on the price confirmation screen of the client terminal 32 used by the pricing person 42.

In addition to the transaction conditions determined by the sales management server 100 and displayed in the transaction condition display section 54 in FIG. 17, the policy for determining the transaction conditions may be displayed at the same time. By displaying the policy of determining the transaction conditions, the sales person 41 can make a proposition what conditions are required to be met to change the transaction conditions at the time of negotiation with the ordering person 46 of the customer company. In the case where the discount rate is low due to a small number of past transactions, for example, the sales person 41 can explain that a future increase in the number of transactions makes it possible to increase the discount rate in subsequent transactions. The availability of the chance of this explanation can persuade the ordering person 46 of the customer company that the discount rate for the current sale is limited to the proposed one.

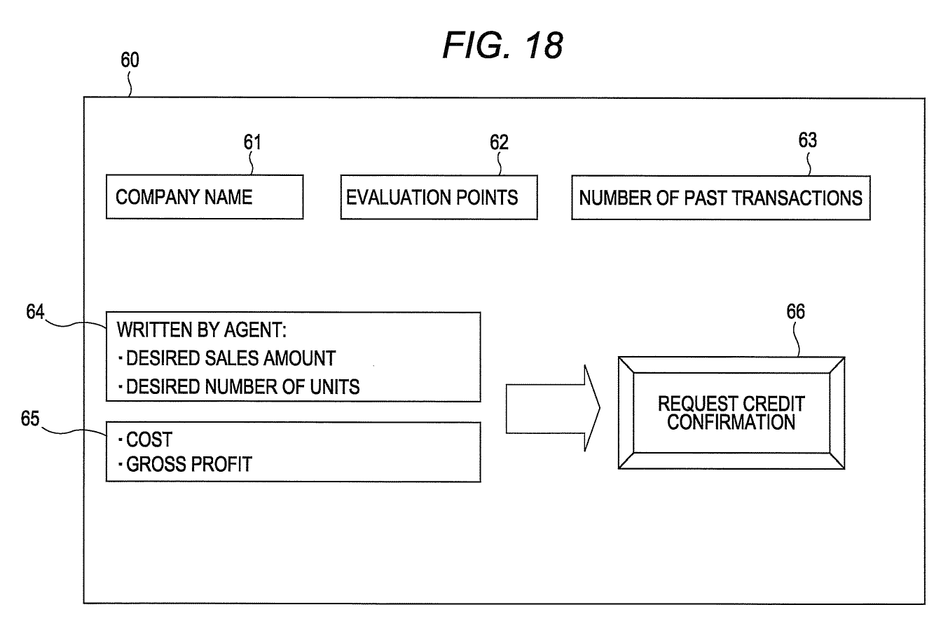

FIG. 18 illustrates an exemplary price confirmation screen 60. The price confirmation screen 60 is displayed at the client terminal 32 when the pricing person 42 confirms the price. The price confirmation screen 60 includes a company name display section 61, an evaluation point display section 62, a transaction number display section 63, an order specifics display section 64, a price determination index display section 65 and a credit confirmation request button 66.

The company name display section 61 displays the name of the customer company desirous of purchasing the commodity. The evaluation point display section 62 displays the evaluation points of the customer company as determined by the credit bureau. The transaction number display section 63 displays the number of orders for which the customer company has thus far negotiated with the distributor.

The order specifics display section 64 displays the order specifics input on the pending-order management screen 50. The price determination index display section 65 displays the information as an index to determine whether the price is proper or not. Examples of the information constituting the index include the commodity cost and the gross profit obtainable if the commodity is sold to the customer at the price desired by the customer. The commodity cost may be acquired from the commodity DB 130.

The credit confirmation request button 66 may be used for requesting the accounting person 43 to confirm the credit standing upon completion of the price confirmation. Upon depression of the credit confirmation request button 66, the pending-order information of which the price has been confirmed is transmitted to the sales management server 100 from the client terminal 32. The pending-order information of the order for which the price confirmation is completed is displayed on the credit confirmation screen of the client terminal 33 used by the accounting person 43.

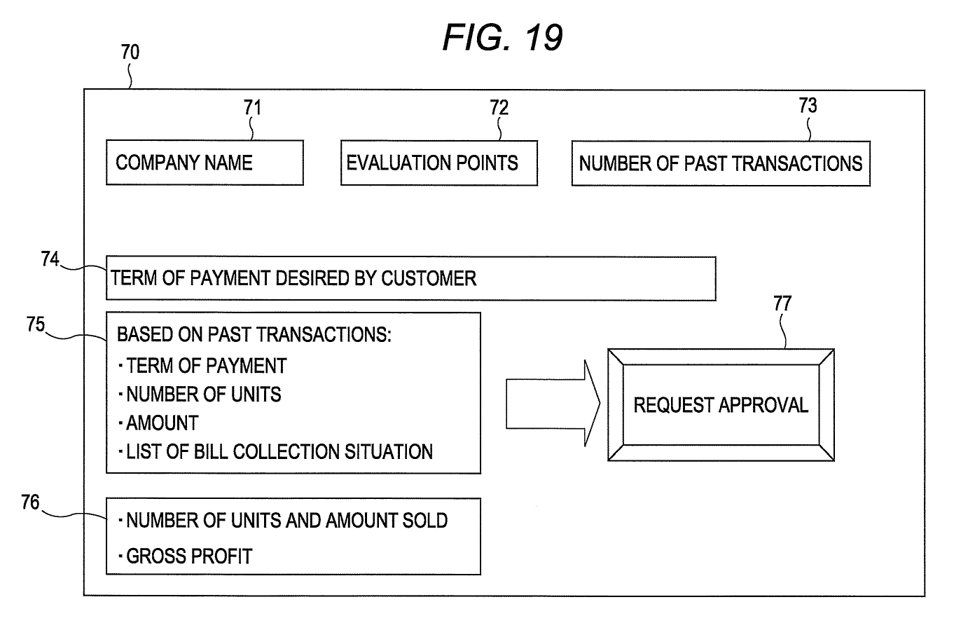

FIG. 19 illustrates an exemplary credit confirmation screen 70. The credit confirmation screen 70 is displayed at the client terminal 33 when the accounting person 43 confirms the credit standing. The credit confirmation screen 70 includes a company name display section 71, an evaluation point display section 72, a transaction number display section 73, a desired payment term display section 74, a past transaction content display section 75, a credit determination index display section 76 and an approval request button 77.

The company name display section 71 displays the name of the customer company desirous of purchasing the commodity. The evaluation point display section 72 displays the evaluation points of the customer company determined by the credit bureau. The transaction number display section 73 displays the number of the orders for which the customer company has thus far negotiated with the distributor.

A requested payment term display section 74 displays the term of payment desired by the customer. The past transaction content display section 75 displays the contents (term of payment, number of units, amount and bill collection situation) of past transactions. The credit determination index display section 76 displays the information constituting an index for determining whether a particular transaction is safe or not. The information as an index of the current transaction, for example, include the number of units sold, the amount and the gross profit.

The approval request button 77 may be used for requesting the manager 44 to grant the approval upon completion of the confirmation of the credit standing. Upon depression of the approval request button 77, the pending-order information of the order for which the credit confirmation is complete is transferred from the client terminal 33 to the sales management server 100. The pending-order information of the order for which the credit confirmation is completed is displayed on the approval screen of the client terminal 34 used by the manager 44.

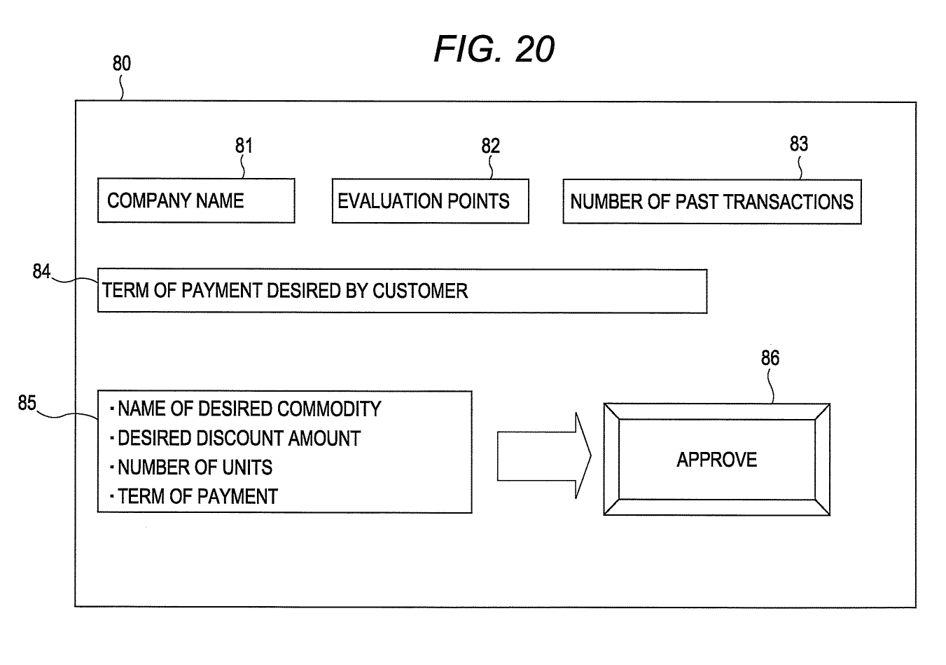

FIG. 20 illustrates an exemplary approval screen. The approval screen 80 is displayed at the client terminal 34 when the manager 44 grants an approval. The approval screen 80 includes a company name display section 81, an evaluation point display section 82, a transaction number display section 83, a desired payment term display section 84, a transaction content display section 85 and an approval button 86.

The company name display section 81 displays the name of the customer company desirous of purchasing the commodity. The evaluation point display section 82 displays the evaluation points of the customer company as determined by the credit bureau. The transaction number display section 83 displays the number of the orders for which the customer company has thus far negotiated with the distributor.

A requested payment term display section 84 displays the term of payment desired by the customer. The transaction contents display section 85 displays the transaction contents (such as the commodity name, discount amount, number of units and the term of payment). The approval button 86 is depressed when the approval is granted. Upon depression of the approval button 86, the approval information indicating the approval is transmitted from the client terminal 34 to the sales management server 100.

As described above, according to an embodiment, the credit information provided by the credit bureau and the transaction conditions for each customer based on the transaction history held by the distributor may be confirmed by the sales person 41 at the time of negotiation with the prospective customer. The negotiation between the sales person 41 and the ordering person 46 of the customer company may be quickened and so can the approval of the order to be concluded by the negotiation. Thus, the contract may be signed quickly, and the loss of the chance of a successful sale may be avoided while at the same time reducing the paperwork load on the sales person 41.

The investigation and the exchange of documents, which are the conventional practice between the sales person and the person in charge at the customer company, may be eliminated. Instead, the information generated by the various processes from the investigation to the examination are computerized. In addition, the approval based on the computerized data has come to promote the quick data exchange between the person authorized for approval and the accounting department. The resulting increased speed of response to the customer inquiry improves the efficiency of the sales activity.

The processing disclosed above may be executed by a computer. A program may be provided which describes the contents of the process executed as the functions to be held by the sales management server 100. By executing this program using the computer, the processing disclosed above may be executed on the computer. The embodiments may be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

To distribute a program, a portable recording medium such as DVD or CD-ROM having the program recorded therein may be sold. The program may be stored in the storage unit of the server computer and transferred from the server computer to other computers through a network.

In a computer for executing a program, for example, the program recorded in a portable recording medium or transferred from a server computer may be stored in the storage unit of the computer. The computer can read the program from the storage unit thereof and execute the process according to the program. The computer can read the program directly from a portable recording medium and execute the process according to the program. Further, each time a program is transferred from the server, the computer can execute the process according to the received program.

As disclosed above in a description of an exemplary sales support apparatus, a computer-readable recording medium having recorded therein the sales support program and the sales support method, may quickly judge transaction conditions taking the contents of the credit information and the customer information held by the distributor into consideration, thereby making it possible to sign a sales agreement quickly.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A sales support apparatus for supporting sales, comprising:
a customer information storage unit storing the credit information of a customer;
a transaction history storage unit storing the history of past transactions with the customer;
a transaction condition storage unit storing the transaction conditions corresponding to the combination of the customer credit information and the transaction history;
a transaction condition determining unit acquiring, upon application thereto of a transaction condition acquisition request from an order terminal designating the customer as the other party of transaction, the credit information of the customer as the other party of transaction from the customer information storage unit, acquiring the history of transactions with the customer as the other party of transaction from the transaction history storage unit, and by accessing the transaction condition storage unit, determining the transaction conditions corresponding to the credit information and the transaction history of the customer as the other party of transaction; and
a transaction condition transmission unit transmuting the transaction conditions determined by the transaction condition determining unit to the order terminal.

2. The sales support apparatus according to claim 1,
wherein the transaction history storage unit has stored therein, in addition to the past transaction information indicating the contents of the past transactions, the in-examination pending-order information waiting for approval after order reception, and
the apparatus further comprises examination management unit for transmitting the in-examination pending-order information of the customer as the other party of transaction, the credit information of the customer as the other party and the past transaction information of the customer as the other party to the approval terminal used by the person responsible for approval, and upon reception of the approval information granting the approval of the transaction from the approval terminal, transmitting the approved in-examination pending-order information to the order terminal.

3. The sales support apparatus according to claim 2, further comprising:
a progress information storage unit storing the confirmation state indicating the confirmation or non-confirmation of the in-examination pending-order information upon approval after the content confirmation of the in-examination pending-order information by the person in charge of confirmation,
wherein the examination management unit transmits the in-examination pending-order information of the customer as the other party of transaction, the credit information of the customer as the other party and the past transaction information of the customer as the other party of transaction to the confirmation terminal used by the person in charge of confirmation of the contents of the in-examination pending order and, upon reception of the confirmation information indicating the completion of the confirmation from the confirmation terminal, sets the progress information of the in-examination pending-order information in the progress information storage unit as “confirmed”, while at the same time transmitting the confirmed in-examination pending-order information to the approval terminal.

4. The sales support apparatus according to claim 3,
wherein in the case where the contents of the in-examination pending-order information are confirmed by a plurality of persons in charge of confirmation, the progress information storage unit includes the confirmation state for each of the persons in charge of confirmation,
the examination management unit transmits the in-examination pending-order information of the customer as the other party of transaction, the credit information of the customer as the other party of transaction and the past transaction information of the customer as the other party of transaction to a plurality of the confirmation terminals used by a plurality of the persons, respectively, in charge of confirming the contents of the in-examination pending-order information,
upon reception of the confirmation information indicating the completion of confirmation from the confirmation terminal, the confirmation state corresponding to the person in charge of confirmation using the confirmation terminal for transmitting the confirmation information is set as “confirmed”, and
upon setting all the confirmation states as “confirmed”, the in-examination pending-order information is transmitted to the approval terminal.

5. The sales support apparatus according to claim 1,
wherein the transaction condition storage unit indicates the upper limit amount of the commodity sales volume as the transaction condition, which upper limit amount is higher the higher the credit standing based on the credit information on the one hand and higher the greater the number of past transactions on the other hand.

6. The sales support apparatus according to claim 1,
wherein the transaction condition storage unit sets the discount rate as the transaction condition, which discount rate is higher the higher the credit standing based on the credit information on the one hand and higher the greater the number of past transactions on the other hand.

7. The sales support apparatus according to claim 1,
wherein the transaction condition storage unit sets the period of the term of payment as the transaction condition, which period is longer the higher the credit standing based on the credit information on the one hand and higher the greater the number of past transactions on the other hand.

8. A computer-readable recording medium having recorded therein a sales support program for supporting sales with a computer, the recording medium causing the computer to serve as:
a customer information storage unit storing the credit information of a customer;
a transaction history storage unit storing the history of past transactions with the customer;
a transaction condition storage unit storing the transaction conditions corresponding to the combination of the customer credit information and the transaction history;
a transaction condition determining unit acquiring, upon application thereto of a transaction condition acquisition request designating the customer as the other party of transaction from an order terminal, acquiring the history of transactions with the customer as the other party of transaction from the transaction history storage unit, and by accessing the transaction condition storage unit, determining the transaction conditions corresponding to the credit information and the transaction history of the customer as the other party of transaction; and
a transaction condition transmission unit transmitting the transaction conditions determined by the transaction condition determining unit to the order terminal.

9. The recording medium according to claim 8,
wherein the transaction history storage unit has stored therein, in addition to the past transaction information indicating the contents of the past transactions, the in-examination pending-order information waiting for transaction approval after order reception, and
the recording medium causes the computer to further functions as: examination management unit transmitting the in-examination pending-order information of the customer as the other party of transaction, the credit information of the customer as the other party of transaction and the past transaction information of the customer as the other party of transaction to the approval terminal used by the person responsible for approval, and upon reception of the approval information indicating the approval of the transaction from the approval terminal, transmitting the approved in-examination pending-order information to the order terminal.

10. A sales support method for supporting sales with a computer executing the operations of:
acquiring, upon receipt of a transaction condition acquisition request designating the customer as the other party of transaction from an order terminal, the credit information of the customer as the other party of transaction from the customer information storage unit for storing the customer credit information;
acquiring the history of transactions with the customer as the other party of transaction from the transaction history storage unit for storing the history of past transactions with the customer;
accessing the transaction condition storage unit for storing the transaction conditions corresponding to the combination of the credit information and the transaction history of the customer;
determining the transaction conditions corresponding to the combination of the credit information and the transaction history of the customer; and
transmitting the determined transaction conditions to the order terminal.

11. The sales support method according to claim 10,
wherein the transaction history storage unit stores, in addition to the past transaction information indicating the contents of the past transactions, the in-examination pending-order information waiting for the transaction approval after order reception, and
the computer transmits the in-examination pending-order information of the customer as the other party of transaction, the credit information of the customer as the other party of transaction and the past transaction information of the customer as the other party of transaction to the approval terminal used by the person responsible for approval, and upon reception of the approval information indicating the transaction approval from the approval terminal, transmits the approved in-examination pending-order information to the order terminal.
